(19) United States
(12) Patent Application Publication
(10) Pub. No.: US 2009/0213371 A1
(43) Pub. Date: Aug. 27, 2009

(54) Spectrophotometer Comprising Two Detectors for Overlapping Wavelength Ranges

(75) Inventors: Ian Goodyer, East Sussex (GB); Tracy Ann Nutall, East Susex (GB); Rudi Labarbe, Bonceluel (BE); Nicholas Salvatore Arini, Southampton (GB); Andrew Seddon, Newport (GB); Nick Stock, Monmouth (GB); Gary Ross, Monmouth (GB); Ralf Patz, Cardiff (GB)

Correspondence Address: MCDONNELL BOEHNEN HULBERT & BERGHOFF LLP, 300 S. WACKER DRIVE, 32ND FLOOR, CHICAGO, IL, 60606, US

(73) Assignee: ZINIR LIMITED, Whitchurch, Cardiff (GB)

(21) Appl. No.: 12/096,908

(22) PCT Filed: Dec. 13, 2006
(86) PCT No.: PCT/GB2006/004657

§ 371 Date: Oct. 28, 2008

(30) Foreign Application Priority Data
Dec. 14, 2005 (GB) 0525408.1

(51) Int. Cl. G01J 3/28

(52) U.S. Cl. 356/319

(57) ABSTRACT

A spectrophotometer has a first photodetector (24) and a second photodetector (25) which is displaced spatially from the first photodetector in the direction of increasing wavelength in the spectrum. At any given time the second photodetector receives light at a wavelength which is substantially greater than that being received simultaneously by the first photodetector at that time. The first photodetector has first range of wavelengths over which it is operable and a first upper operating limit, and the second photodetector has a second range of wavelengths over which it is operable and a second upper operating limit, the second range overlapping the first range and the second upper operating limit being greater than the first upper operating limit. Thus the range of operation is extended, and data in two different ranges is processed simultaneously. The spectrophotometer comprises a housing (1) containing a light source (11), a monochromator (15, 16, 18) and the photodetectors, there being a fibre optic connected to a probe (2) for transmitting light from the light source to a sample to be analysed and receiving light from the sample. Optical components are mounted to a chassis (26) of the housing rigidly, the chassis being connected to the housing by shock absorbing mounts (28, 29). The light source is mounted to the housing by means of an adjuster (24) providing for adjustment laterally with respect to the optical axis of the light source.

This invention relates to a spectrophotometer.

Spectrophotometry is the study of electromagnetic spectra. A spectrophotometer is a device for measuring light intensity, that can measure the intensity of light as a function of colour, i.e. the wavelength of light. The most common application of spectrophotometers is to measure light absorption, but they can be designed to measure, for example, diffuse reflectance or the emission spectrum of a fluorescent or phosphorescent molecule.

In general, spectrophotometers are not robust and are prone to damage or malfunction if moved. In particular the spectrophotometer optics and monochromators are prone to damage due to movement/vibration of the instrument. Furthermore, spectrophotometers are sensitive to the environment in which they operate such as for example a dusty, corrosive or hazardous environment. As a result most spectrophotometers are to be found in the laboratory and if found outside the laboratory are located in an environment where their movement/vibration is minimal or controlled. Spectrophotometers that have been designed for use outside of the laboratory have tended to use optics/monochromators which offer poor sensitivity and resolution and are limited in their range of capabilities. Further these spectrophotometers are often slow.

Viewed from one aspect, the present invention provides a spectrophotometer comprising means for directing light having a plurality of wavelengths to means arranged to produce a spectrum of different wavelengths distributed spatially, a first photodetector for receiving at any given time light in said spectrum within only a relatively narrow range of wavelengths, and means for effecting relative movement between the first photodetector and the spectrum so that the range of wavelengths received by the photodetector varies as a function of time; wherein there is provided a second photodetector which is displaced spatially from the first photodetector in the direction of increasing wavelength in the spectrum, the means for effecting relative movement between the first photodetector and the spectrum also effecting relative movement between the second photodetector and the spectrum, whereby at any given time the second photodetector receives light in said spectrum within a relatively narrow range of wavelengths which are substantially greater than those of the relatively narrow range of wavelengths being received simultaneously by the first photodetector at that time; and wherein the first photodetector has a first range of wavelengths over which it is operable and a first upper operating limit, and the second photodetector has a second range of wavelengths over which it is operable and a second upper operating limit, the second range overlapping the first range and the second upper operating limit being greater than the first upper operating limit.

Thus, the two photodetectors will simultaneously detect light, but over different wavelength bands, and between them will provide a range of operation that exceeds that which could be provided if using a single photodetector or an array of identical photodetectors. Both the speed and versatility of the spectrophotometer are thereby enhanced.

It will be appreciated that for any particular wavelength range, instead of a single photodetector there could be a plurality of adjacent identical or similar photodetectors.

It will also be appreciated that the wavelength range could be divided up between more that two photodetectors, and in general there may be a plurality of photodetectors positioned to receive light over different wavelength ranges and having different operable wavelength ranges and different upper operating limits.

In general, and viewed from another aspect, the present invention provides a spectrophotometer comprising means for producing a spectrum of different wavelengths or light distributed spatially and for directing the spectrum to a plurality of photodetectors spaced from each other in a direction such that at any given time each of the photodetectors receives light in a part of the spectrum which is different to that part of the spectrum in respect of any other of the photodetectors, the photodectors having different response characteristics so that different photodetectors provide optimal outputs for different parts of the spectrum.

The means arranged to produce a spectrum of different wavelengths distributed spatially preferably comprises a monochromator.

Using a typical monochromator, the spectrum is spread out across a physical region in the plane of a detector. As a diffraction grating rotates, the image of the spectrum moves across the detector plane. The bandwidth of the signal is determined by the width of a slit placed in the detector plane, thus allowing only energy in a small section of the spectrum to hit the detector. To get coverage of wavelengths over more than an octave, filters are necessary to separate the diffraction orders, i.e. to prevent the second order diffraction from a short wavelength being mixed up with the first order of a longer wavelength. One way of achieving such filtering using a conventional system would be to incorporate a beam splitter so that long wavelengths went to one detector and short wavelength went to a second detector.

The loss of energy through a beam splitter could be quite large and would reduce the signal/noise and hence the ultimate sensitivity of the instrument. The arrangement in accordance with the invention uses a second detector in a different position so the need for a beam splitter is removed and the overall throughput improved.

The spectrophotometer may comprise excitation optics, detection optics and a microprocessor, in which the excitation optics comprises a light source, light focussing means and means for guiding the light to a sample to be analysed, and in which the detection optics comprises means for receiving modified light from the analysed sample, and means to convert the received modified light from the sample into an electrical signal for interpretation by a microprocessor, the microprocessor comprising a reference library and a sample determination algorithm for comparing the received electrical signal to a library of reference electrical signals to identify a compound or class of compounds in the sample whereby, in use, the light emitted by the light source emits light which is focussed by the light focussing means onto the means for guiding the light to the sample, the light guiding means guides the light to the sample, the sample modifies the received light and transfers a modified light signal indicative of the nature of the sample which signal is received by the light receiving means which conveys the signal to the light converter means, the light converter means comprising the plurality of photodetectors. The photodetectors are capable of detecting different wavelengths of light, and in one preferred arrangement such that the information received can be formed to make a contiguous spectrum which is usable for interpretation of the modified light to determine the nature of the sample.

Advantageously, a spectrophotometer of this type provides a means for guiding the light to a sample to be analysed and a means for receiving modified light from the analysed sample. Thus there is spatial separation of the components of the spectrophotometer which are sensitive to movement/vibration from the sample which reduces the likelihood of these components being subjected to movement/vibration. This separation also allows for the sensitive components not to be in the environment of the sample which may be detrimental to the spectrophotometer. Furthermore this separation allows information to be obtained from environments where it would be impractical to operate a conventional spectrophotometer. Such environments may include but are not limited to for example, difficult to reach or confined spaces.

In one embodiment, the spectrophotometer comprises an internal chassis upon which movement sensitive components are mounted and said chassis is connected to an external cover by one or more shock absorption or shock retardation means. In a preferred embodiment the chassis is suspended so that it is free to move relative to the outer casing by encasing areas of the chassis in a shock absorbing/retarding means such as rubber or some other form of shock absorbing or shock retarding means. In a preferred option the internal chassis holds the mirrors, diffraction grating, detection filters and slits.

Thus, viewed from another aspect the present invention provides a spectrophotometer comprising a housing containing a light source, a first light transmitting connection between the housing and a probe for transmitting light from the light source to a sample to be analysed, a second light transmitting connection between the housing and the probe for receiving light from the sample to be analysed, and, within the housing, optical components comprising means for directing the received light to means arranged to produce a spectrum of different wavelengths distributed spatially, and at least one photodetector for detecting light in the spectrum, wherein the optical components are mounted rigidly to a chassis which is mounted within the housing by means for at least partially absorbing shock and/or vibrations.

A spectrophotometer of this type provides a means to directly shield the movement/vibration sensitive components of the spectrophotometer from an environment in which it may be subject to movement or vibration. It will be appreciated that the spectrophotometer may also be in accordance with other aspects of the invention and for example may have a plurality of photodetectors as discussed earlier.

A further problem is that the light source of a spectrophotometer may only have a finite life and may need replacing at the end of its life and the replacement may show different characteristics. It is further envisaged that a first type of light source such as a light bulb, may be replaced by a second type of light source e.g. a LED array, within the excitation optics train. In this case a desirable feature of the spectrophotometer is that the position of the light source is capable of independent adjustment.

Thus, viewed from another aspect there is provided a spectrophotometer comprising a housing containing a light source, a first light transmitting connection between the housing and a probe for transmitting light from the light source to a sample to be analysed, a second light transmitting connection between the housing and the probe for receiving light from the sample to be analysed, and, within the housing, means for directing the received light to means arranged to produce a spectrum of different wavelengths distributed spatially, and at least one photodetector for detecting light in the spectrum, wherein the light source is mounted by means of an adjuster providing for adjustment laterally with respect to the optical axis of the light source.

It will be appreciated that the spectrophotometer may also be in accordance with other aspects of the invention and for example may have a plurality of photodetectors, or shock and vibration absorbing means as discussed earlier.

In embodiments of the various aspects of the invention, preferably the light source in the spectrophotometer is polychromatic in nature. However, it is envisaged that in certain embodiments the spectrophotometer may have one or more monochromatic light sources, or light sources which emit light in a narrow wavelength range of light. Such a light source could be for example a laser or a light emitting diode. In a preferred embodiment the light source emits light in the near infra-red wavelength range. In one preferred embodiment the light source emits light in the wavelength range of about 900 nm to about 2.5 μm. However, the spectrophotometer may also find utility with the use of ranges of wavelengths of light which are longer than the wavelengths of light in the NIR range, or shorter than the wavelengths of light in the NIR range. When longer or shorter wavelengths of light are used optimisation of other components of the spectrophotometer may be necessary to take account of the change of wavelengths of light.

When a polychromatic light source is used it is desirable that the light source exhibits a spectral curve and stable output and that the light source does not exhibit sharp spectral peaks. These characteristics may be achieved by using a single light source, or a combination of light sources which individually do not have all the desired characteristics but collectively do. In part such characteristics may be regulated by the stabilization and optimisation of the power supply to the light source. The light source may be, for example, a bulb, arc lamp, light emitting diode or laser. Optionally the spectrophotometer may comprise more than one light source, or be provided with readily interchangeable light sources, wherein each of the light sources may be different and selected independently from available sources such as a bulb, arc lamp, light emitting diode or laser. This has the advantage in that the characteristics of the light source may be optimised for a defined use. For example if a sample to be analysed is in a container whose properties are such that it absorbs much of the emitted light from the probe it may be advantageous to compensate by increasing the amount of light exciting the probe.

In one embodiment the light source is a quartz tungsten halogen bulb, as this type of bulb displays a smooth spectral curve, a stable output and does not exhibit sharp spectral peaks.

It is desirable that the excitation optics of the spectrophotometer are optimised to ensure that sufficient light is delivered to the sample to be analysed.

Preferably, means for guiding the light to a sample is a fibre optic cable. When a fibre optic cable is used it is advantageous that the fibre optic cable is optimised for low attenuation of the light passing through it; preferable the type of fibre optic cable is that known as a LOH fibre. Further, the position of the end of the fibres that connect to the spectrophotometer and the probe is such that the flow of light from the light source to the probe, and the return from the probe to the detector optics, is optimised.

In a preferred option the spectrophotometer is characterised in that the optical probe optimises both the light received by the sample and the modified light reflected, scattered or transmitted by the sample. The modified light received by the optical probe can be in the form of transmission light, reflected light, transflected light and interacted light.

In a preferred embodiment, the monochromator is a moving monochromator, and preferably a Czerny-Turner type monochromator. However, other types of monochromators known in the art are envisaged, such as those relying on optical dispersion by a prism or others using diffraction by a grating. The type of monochromator used will be determined by the use requirements of the spectrophotometer. When the monochromator is a moving monochromator, the monochromator may comprise a light diffraction grating such as a volume holographic transmission grating, ruled surface relief diffraction grating, or holographic surface relief reflection grating.

When the light source does not have an integral collimator means, it is envisaged that the excitation optics further comprises a collimator.

As previously indicated the characteristics of the light source may vary with time and condition, or the light source may suffer from failure. Therefore, preferably there is provided at least one reference photodetector to monitor the output of the light source.

The photo-detector(s) of the spectrophotometer may be of any suitable type, such as photo-resistor or light dependent resistor, photo-voltaic cell, solar cell, photo-diode, photo-multiplier tube, photo-tube containing a photo-cathode, photo-transistor, or a sensor that detects light via a change in temperature due to illumination. However, any suitable means known in the art by which light can be detected could be used.

In embodiments of the invention, the main photodetectors may collectively detect light in the wavelength range of about 700 nm to about 2500 nm, for example in a range of from (a) about 800 nm to about 1,000 nm to (b) about 2,000 nm to 2,200 nm. In a preferred embodiment the preferred range is about 900 nm to about 2000 nm to 2100 nm. In a system using two photodetectors, the operable wavelength ranges of the first and second photodetectors may overlap in a wavelength range of about 1400 nm to about 1600 nm. In one arrangement, the first photo-detector has an operable wavelength range of about 900 nm to about 1600 nm, and the second photo-detector has an operable wavelength range of about 1400 nm to about 2000 nm to 2100 nm. However, it is envisaged that three or more photo-detectors could be used to detect the light in the wavelength range of about 900 nm to about 2000 nm to 2100 nm.

Optionally the position of each detector within the spectrophotometer is adjustable.

In one preferred arrangement, a housing is divided in two compartments. In one compartment are the excitation optics comprising a light source and conditioning optics to couple the light into a fibre optic. In the other compartment are the detection optics consisting of two mirrors, a diffraction grating and two detectors with associated slits and filters.

The fibre optic delivers the light to the optical probe. The probe sends the light onto the sample and collects the reflected or transmitted light and feeds it back into another fibre optic that delivers the light to the entrance of the monochromator.

Preferably the detection optics comprise a slit optimally arranged in front of the light sensitive surface of a photodetector between the photodetector and monochromator to limit the range of wavelengths of light reaching the photodetector. Preferably, the position of each slit within the spectrophotometer is adjustable. Preferably the detection optics comprise a plurality of filters arranged in front of the slit, between the slit and the monochromator, to prevent unwanted light impinging upon the photo-detector. In a preferred option the position of each filter is adjustable. In a further preferred option one or more baffles are positioned to prevent unwanted light impinging on the photo-detector.

Preferably, the spectrophotometer will have at least one self-contained power source such as a battery.

The spectrophotometer may communicate with external data processing means by means of a wireless connection or via a cable and a communications port. It is further envisaged that the spectrophotometer may also comprise a means to determine its geographical location. Such a means may be for example a radio beacon or a global positioning system. In a further option the spectrophotometer may interact with other instruments such as a global positioning system, a barcode apparatus, memory card etc. by a wire or wireless connection.

A spectrophotometer in accordance with the various aspects of the invention is preferably portable and capable of being carried by a person, for example by hand using a handle; or by being carried from the shoulder using a strap or the like; or by being carried in the manner of a back pack. However, the instrument may be mounted on a vehicle, vessel or aircraft or form part of a production line.

Preferably the spectrophotometer further comprises a means to input and receive information and a means to view said information. Optionally these means are designed so that such a spectrophotometer can be operated by a person wearing protective equipment such as gloves, protective hood or coveralls; for example protective equipment which is commonly known as a nuclear-biological-chemical suit.

In a preferred embodiment the spectrophotometer can account for the modifications of electrical signal induced by sample temperature before comparing it to a library of reference electrical signals to identify a compound.

As used herein the term “monochromator” refers to an optical device that transmits a mechanically selectable narrow band of wavelengths of light chosen from a wider range of wavelengths; the term “lens” refers to a device for either concentrating or diverging light; and the term “photodetector” refers to a sensor of light or other electromagnetic energy.

An embodiment of a spectrophotometer in accordance with the various aspects of the invention will now be described by way of example and with reference to the accompanying drawings, in which:

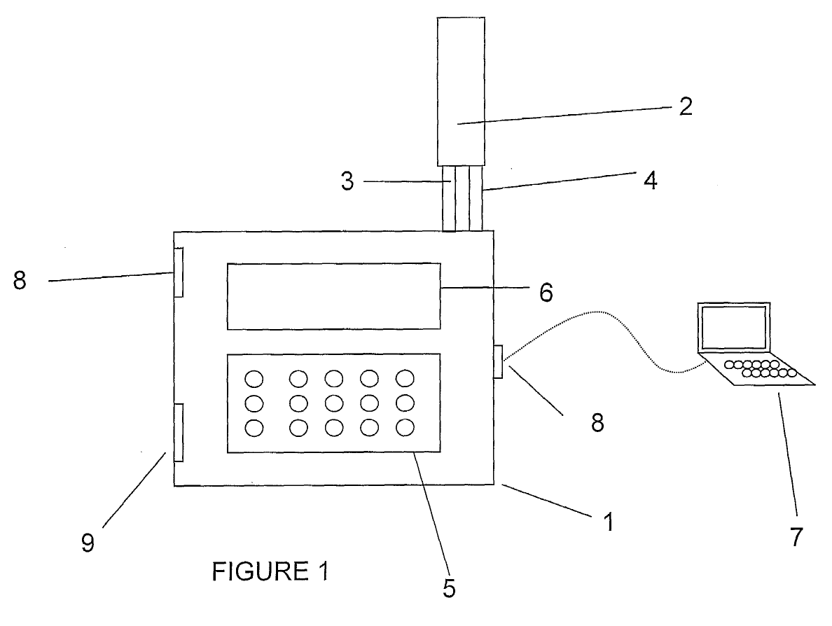

FIG. 1 is an overall view of a spectrophotometer in accordance with the invention;

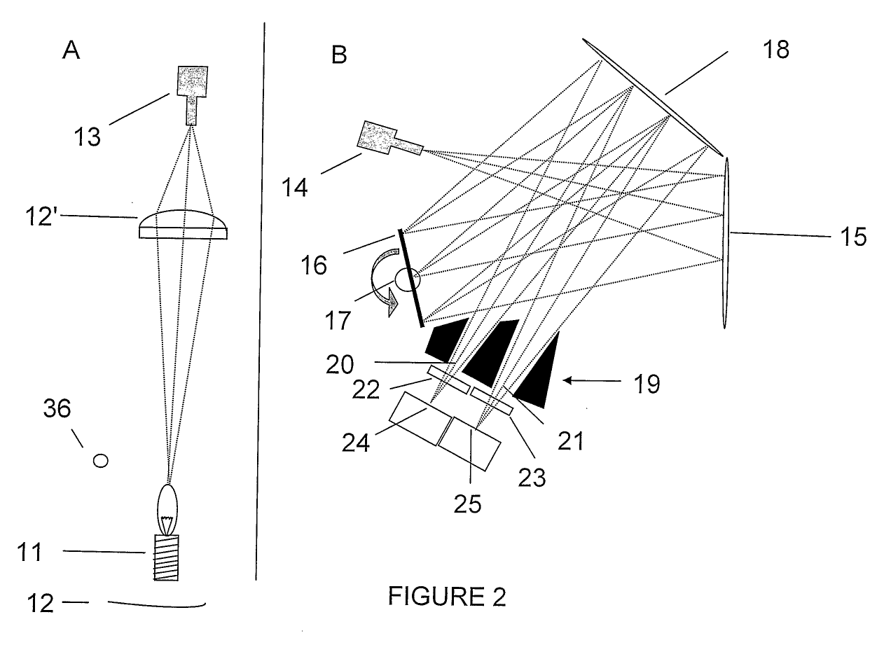

FIG. 2 is a schematic diagram of the optics within the device;

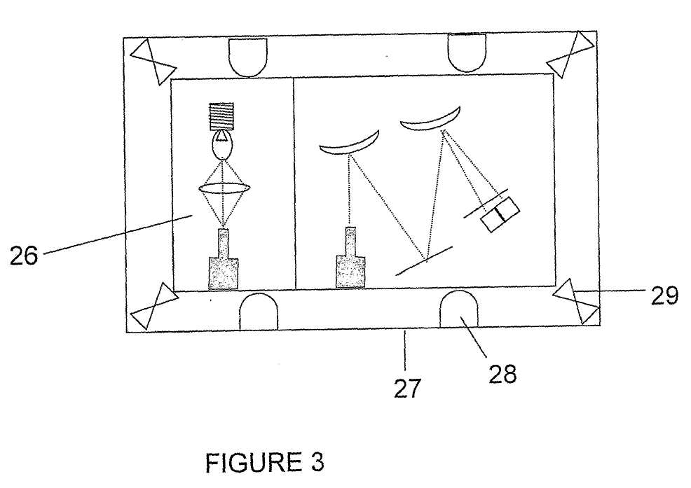

FIG. 3 is a schematic diagram of how optical components are mounted within the device;

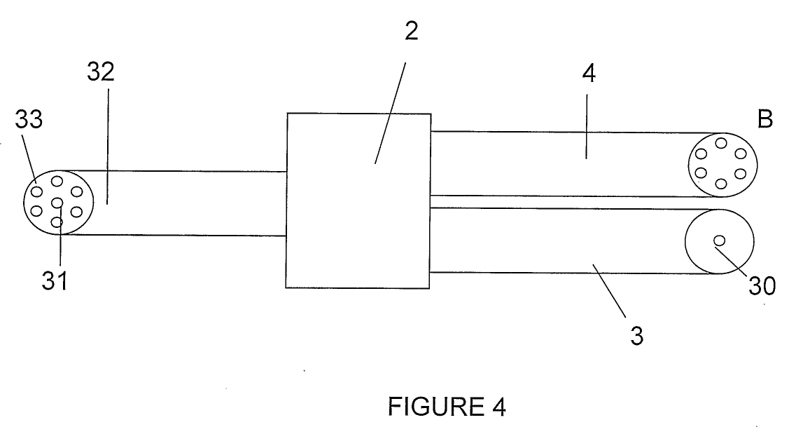

FIG. 4 is a schematic diagram off a probe for use with the device;

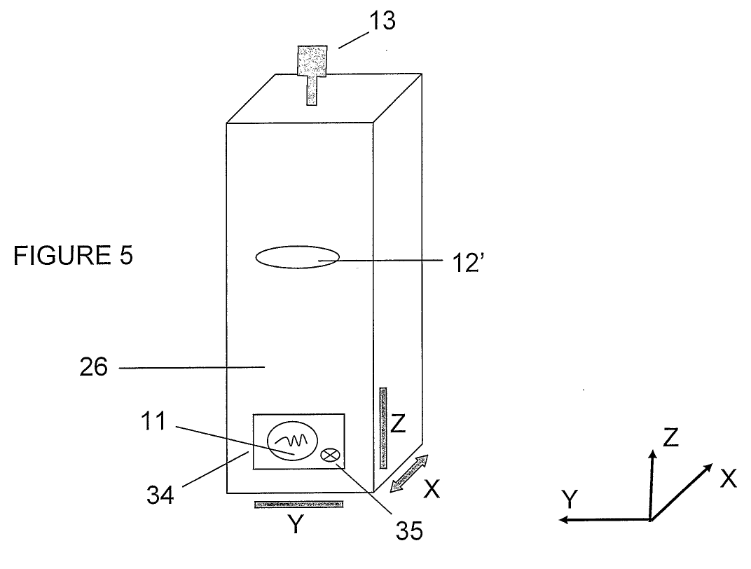

FIG. 5 is a schematic diagram showing the adjustability of a light source;

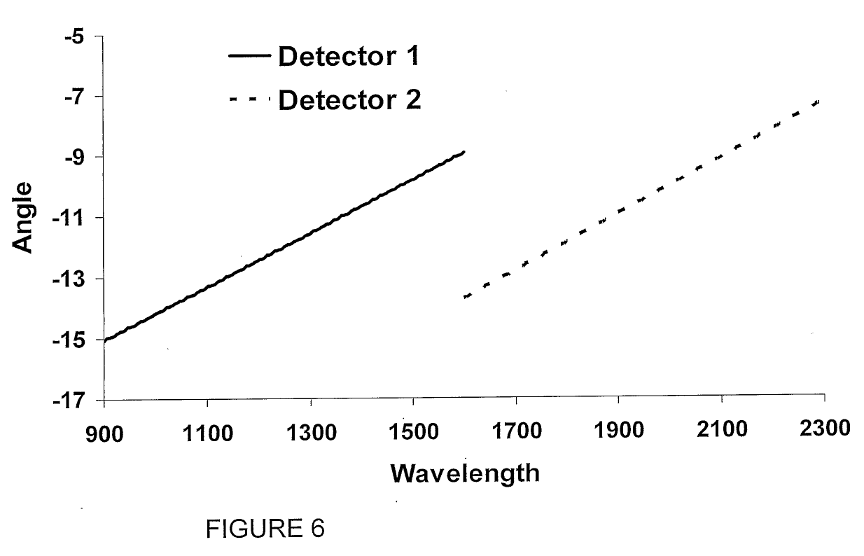

FIG. 6 shows the correlation between the grating angle and the wavelength of light reaching the detectors;

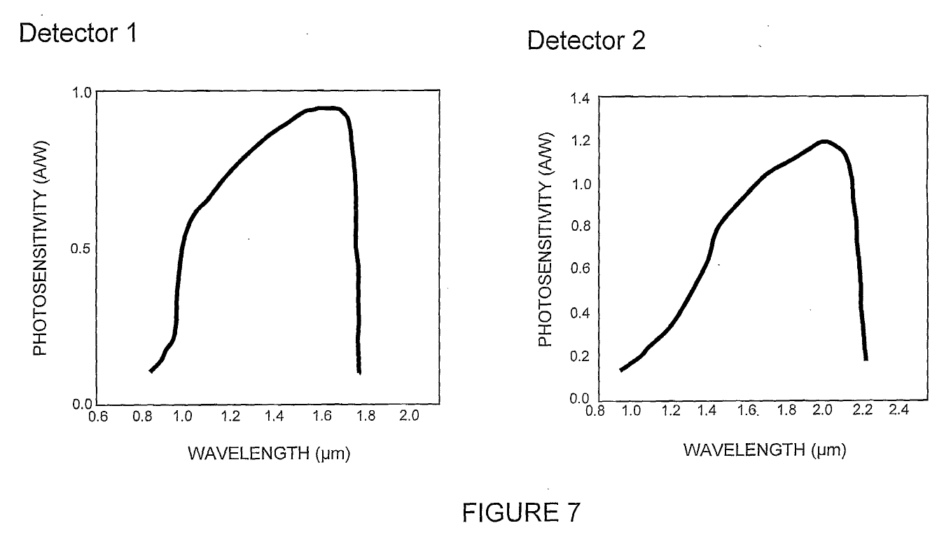

FIG. 7 shows the spectral responses of the two detectors; and

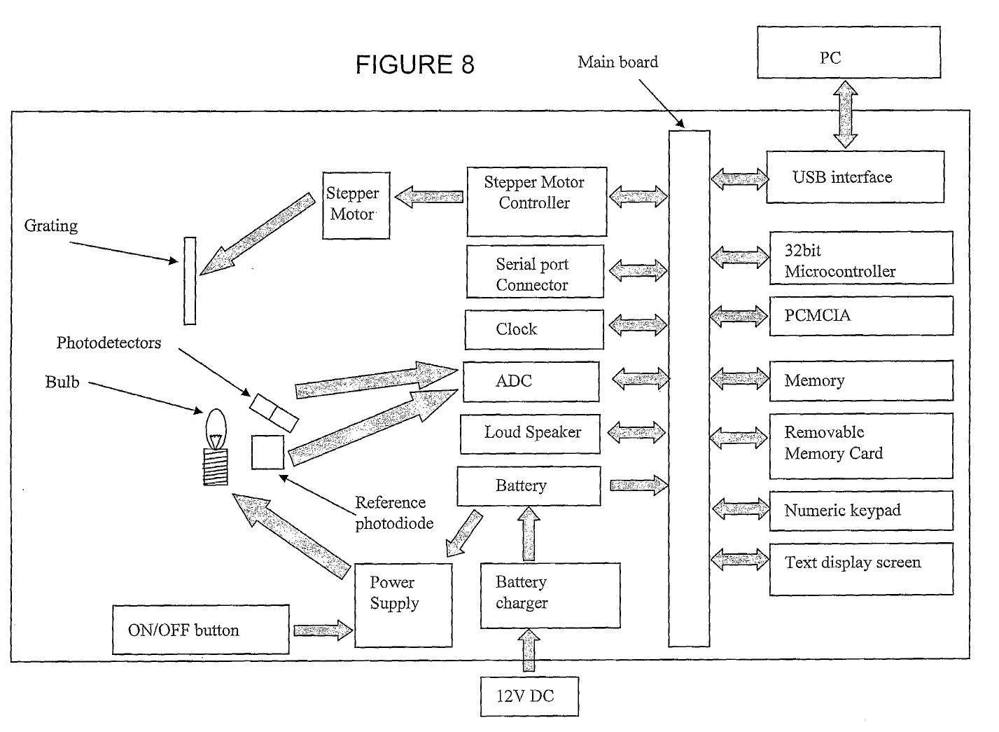

FIG. 8 is a schematic view of components of the device.

The spectrophotometer consists of two main parts, a main module 1 and an optical probe 2 connected detachably to the main module by fibre optic cables 3 and 4. The main module 1 is a completely independent and stand alone unit. It contains the optics and electronics, as described later. It is provided with a keypad 5 and a display, such as an LCD display 6. The main module is optionally connected to a computer 7, such as a laptop, by a cable to a USB port 8. The main module also has an expansion card slot 8 allowing storage of reference spectra and collected data. A memory card can be used to load new spectral fingerprints in the spectrophotometer. The main module can also be connected via a PCMCIA slot 9 to several interfaces to increase its functionality including a memory card, a GPS receiver, a barcode reader, or connection card to a Bluetooth network or a mobile phone network allowing the connection of the instrument to the internet, for example. The main module is designed to have an open architecture so that it can be connected to many different devices for the collection of metadata and for communicating with the external world.

The optical probe 2 delivers light to a sample, collects the reflected light and sends it back to the main module. Depending on the type of sample being investigated, the geometry of the probe will be different. Swapping the optical probes can be done very easily by the customer by disconnecting the fibre optic from a connector on the main module and connecting the new optical probe.

The main module 1 comprises three main components: Excitation optics; Detection optics; and an Electronics module.

With reference to FIG. 2, the main module 1 is divided into two compartments. Compartment A contains the excitation optics comprising a bulb 11, a mirror 12, a lens 12′ and a connector 13 for fibre optic cable 3. Compartment B contains a connector 14 for fibre optic cable 4, a first mirror 15, a plane ruled diffraction grating 16 which is rotated by a stepper motor 17, a second mirror 18, a baffle assembly 19 providing slits 20 and 21, filters 22 and 23, and photodetectors 24 and 25.

FIG. 3 is a schematic diagram of how the optical components are mounted within the main module 1. The components 11 to 25 are each mounted rigidly on a main rigid chassis, frame, board or the like 26. This is in turn mounted to an outer chassis or the like 27 by, for example, resilient mountings/dampers or the like 28 and springs or other resilient means 29. This arrangement ensures that the optical components remain aligned, and are protected from vibration and shocks, which are reduced or eliminated by the mounting arrangement.

FIG. 4 is a schematic diagram of the probe 2. The excitation light from connector 13 enters a central 200 μm fibre 30 of the fibre optic cable 3. It is directed to a main part of the probe 2, where it is merged in to a central part 31 of a fibre bundle 32 at the probe end. The light collected by the probe end, i.e. light reflected (diffuse reflectance) by the sample, is directed back to the spectrophotometer by being focussed on 6×200 μm optical fibres 33 of the external corona of the bundle 32. It is directed to the main part where it is separated to pass up fibre optic 4. At the detection end, the light comes out of the corona of the bundle to the connector 14.

The fibres are inserted in protective tubing, in order to make their handling easier and to protect them. The optical probe comprises a single lens. The same optical train is used for both illumination and collection of the light.

The probe has been designed for the observation of an object situated at 1 cm in front of the front lens. The probe forms a light spot of around 1 mm diameter on the sample. Optionally the optical assembly could be inserted in a cylindrical tube that extends beyond the front lens, for example by about 10 mm. This would allow the user to reproducibly position the front lens at the correct distance from the sample surface by placing the tube in contact with the sample. Furthermore, the tube would prevent external light from reaching the monochromator.

The light reflected by the sample and received by the connector 14 is delivered to the detection optics. The diffraction grating 16 separates the spectral components of the light. The different wavelengths are focused at different points in space. By placing the slits 20 and 21 slit in front of the detectors 24 and 25, it is possible to only record the intensity of a small fraction of the light spectrum. By rotating the grating 16 by means of the stepper motor 17, light of different wavelengths is scanned in front of photodetectors. 24 and 25. The two photodetectors are spaced from each other, with different spectral sensitivity, and are used to optimise the detection limit, achieve a high sensitivity across the wavelength range, and increase the data acquisition speed.

The detection optics are based on a modified version of the Czerny-Turner mount, using the planar line grating to achieve the diffraction of the light.

In the excitation optics, the filament of the bulb 11 is placed near the focus of the spherical or parabolic mirror 12 that collimates the light. The body of the bulb is placed parallel to the surface of the mirror. The rays close to the optical axis are reflected by the mirror and collected by the lens 12′. The position of the mirror and of the bulb can be set independently. The lens focuses the collimated light onto the fibre input 3. The fibre is connected to the casing of the instrument by a releasable connector such as an SMA connector. The lens not only focuses the light reflected by the mirror, it also focuses the light travelling directly from the filament. The distance between the filament and the fibre is selected so that the image of the filament, for the direct light, is focused onto the fibre input. Furthermore, the distance between the filament and the lens is as short as possible in order to increase the solid angle of the light collected by the lens.

The collection efficiency is determined by: the diameter of the fibre and the size of the image of the light bulb and the acceptance angle of the fibre (N. A.=0.22). The coupling efficiency between the light bulb and the fibre in this design is around 4%. The total power emitted in the NIR is around 10 W and consequently approximately 160 mW are coupled into the fibre.

With reference to FIG. 5, the Z-axis is along the optical axis. The X and Y axis are orthogonal to the optical axis. The Y axis is parallel to the long axis of the filament. The position of the fibre along the Y axis is not critical. However, because the lens forms a very narrow image of the filament along the X axis, it is important that the fibre is properly aligned with the optical train. The small size of the filament image is necessary in order to obtain a good coupling of the light into the fibre. It should therefore be noted that a displacement of the filament along the Y direction when replacing the light bulb is not critical, as the image of the filament is significantly longer than the diameter of the fibre. A displacement of the filament in the Z direction (i.e. along the optical axis) is not critical, provided it is within suitable limits, for example +/−1.00 mm. However, a displacement in the X direction is very critical. A small displacement of the filament will shift the image. A light source mounting 34 therefore provides a mean to adjust the position of the light bulb 11 in the X-direction allowing the maximum coupling to be obtained. A locking screw or the like 35 is used to hold the mounting 34 in an appropriate position with reference to the chassis 26.

In the present embodiment the light source is a QTH (Quartz Tungsten Halogen) light bulb providing visible and NIR output.

The light bulb is preferably installed on a socket providing easy removal by the customer when the bulb has reached its lifetime. Software monitors the lamp intensity, via a reference photodiode 36 in order to determine when the light bulb is too old and requires replacement, in order to correct the intensity of the detected signal to account for any fluctuation in the light source.

The light collected by the probe from the sample is fed into the Czemy-Turner (CZ) monochromator. Although the two mirrors 15, 18 function in the same separate capacities as the single spherical mirror of a Fastie-Ebert configuration, i.e., first collimating the light source, and second, focusing the dispersed light from the grating, the geometry of the mirrors in the Czerny-Turner configuration is flexible. By using an asymmetrical geometry, the Czerny-Turner configuration produces a flattened spectral field and good coma correction at one wavelength. Spherical aberration and astigmatism will remain at all wavelengths. It is also possible to design a system that may accommodate very large optics.

In the Near Infra Red spectrum of compounds there are several interesting spectral regions that can be used to determine composition and concentration of individual chemical components.

Relatively short wavelengths (900-1,600 nm). This is the spectral region of the first detector 24. This region tolerates longer sample path-lengths (5-30 mm) but yields poorer spectral resolution. The blaze wavelength of the diffraction grating (1300 nm) is in this spectral region. The monochromator design has been optimised so that the light at 1300 nm hits the monochromator at the blaze angle.

Longer wavelength (1,400-2,100 nm). This is the spectral region of the second detector 25. This region requires shorter path length but provide better spectral discrimination. This region is more adequate to identify a component whose bands are not well resolved from the sample matrix or is present in a lower concentration because the absorption bands will be stronger. The monochromator design has been optimised so that the coma aberration is reduced to a minimum in this spectral range. This will give the highest spectral resolution on the second detector. This is useful, as the spectra usually contain some narrow bands in this region.

The first mirror is used to collimate the light from the incoming fibre optic onto the plane ruled diffraction grating. The different wavelengths are reflected by the grating at different angles. The second mirror re-focuses the diffracted light onto the two different detectors 24, 25. The two long pass filters 22, 23 remove the higher diffraction orders. The slits 20, 21 are provided in front of their respective detector to allow only a limited range of wavelengths to reach the detector.

The two detectors with different spectral responses detect simultaneously two different wavelengths.

The slits are preferably mounted on the chassis by means of a translation stage that is adjustable in the Z direction (in the local reference frame) for alignment during assembly.

By rotating the grating from −15.05° to −2.65° (with respect to the bisector of the deviation angle between the incoming and diffracted beam), the spectrum will be scanned in front of the two detectors. The detectors will record the intensity as a function of the grating angle. With appropriate calibration, the grating angle can be converted into wavelength. The grating is rotated by a stepper motor. In the present embodiment, the stepper motor has a step angle of 1.8° and the grating rotates through an angle of 12.4° in 500 steps.

In order to minimise coma in the system, it is necessary that the optical system respects the following conditions. 1. The angle between the chief ray and the optical axis of the first mirror should be as small as possible, i.e. try to be as paraxial as possible. 2. The chief ray hits the centre of both mirrors. 3. The angle between the chief ray and the optical axis of the mirror should be equal for both mirrors.

The minimum distance between the two detectors in the present embodiment is 16 mm. As the monochromator linear dispersion in this embodiment is 31 nm/mm, this means that the minimum separation between the wavelengths of the two detectors is: Δ=31×16=496 nm. Therefore, if the first detector receives light at 1300 nm, the second detector will have to receive light at 1800 nm.

At 1800 nm, the angle between the chief ray and the optical axis of the first and second mirrors are equal (7.5°). Therefore, the coma in the image formed on the first detector should be minimal. The spectral resolution of the second detector is optimised. Indeed, this is the wavelength range that gives spectra with the better resolved bands. It is therefore important that the spectral resolution is as high as possible for this detector.

On the other hand, the angle between the chief ray at 1300 nm and the optical axis of the second mirror is 12.5 deg. There will be some coma left in the image formed onto the first detector, which will reduce the spectral resolution at the second detector. This is less important as the spectra in this spectral region have usually less defined bands.

The image of the circular fibre optic is a line. This is due to the astigmatism of the system. However, the only critical parameter for the determination of the spectral resolution of the system is the dimension of the image in the Y direction. The RMS Spot Y size is around 40 μm in the present embodiment. As the theoretical Airy disk for the system is 14 μm, the optical design is not diffraction limited.

Table 1 shows the characteristics of the two detectors used in the spectrophotometer, and Table 2 shows the specifications of the monochromator used in the system.

TABLE 1

| | | Spatial | Spectral |
|---|---|---|---|
| | Spectral range | Resolution = | Resolution |
| | (nm) | Image size (μm) | (nm) |
| Detector 1 | 900 to 1600 | 300 | 9.3 |
| Detector 2 | 1400 to 2100 | 300 | 9.3 |

TABLE 2

| Bandpass (theoretical) | 6.8 | nm |
|---|---|---|
| Deviation angle Dᵥ | 22.8° | |
| Diffraction Order (k) | 1 | |
| Grating Groove density (n) | 293.53 | groove/mm |
| Effective exit focal length L_{B} | 100 | mm |
| Linear Dispersion dλ/dx | 31 | nm/mm |
| Grating Blaze wavelength | 1300 | nm |
| Grating Blaze angle | 11° | 40′ |

| | |
|---|---|
| F/# | 3.0 |

FIG. 6 shows the correlation between the grating angle and the wavelength of light reaching the first detector and the second detector. There is a good linear relationship between the monochromator angle and the wavelength.

The blaze wavelength is 1300 nm, for the first order diffraction. It should be noted that there is therefore also a blaze wavelength of 1300/2=650 nm for the second order diffraction. Long pass filters in front of the detectors will block the second (and higher) diffraction orders.

In the following section, when referring to the slits the axis refer to the local reference frame. The local Z axis is defined as the local optical axis at the position of the slit. The normal to the surface of the slit is along the local Z axis. The local Y axis is perpendicular to the local Z axis. The short dimension of the slit is along the Y axis. The local X axis is perpendicular to the local Z axis. The long dimension of the slit is along the local X axis.

The image formed on a slit is not symmetrical. The elongation in the X direction is six times larger than the elongation in the Y direction for the first detector 24. The spectral resolution is limited by the spread in the Y direction. Therefore, the spatial resolution of 300 μm will be the limiting factor for the spectral resolution. The slit should have a width of 300 μm in the present embodiment. The maximum extent of the image in the X direction is 1.7 mm. Therefore, the slit should have a length of 2 mm. At the second detector 2, the slit should have a width of 300 μm. The slit should have a length of around 1 mm.

The Z position (in the local reference frame) of the slit is used as a compensator. The Z-position (in the local reference frame) of the slits is adjusted during initial assembly for the precise alignment of the system.

In order to reduce the amount of stray light, some baffles are installed near the fibre input. Further baffles are installed in front of the detectors in order to collect on the detectors only the light reflected by mirror 18. The baffle assembly 19 is composed of a single triangular block. Two holes are drilled in the block. The holes have the shape of a truncated cone. The apex of the cone is 27 mm behind the edge of the block. The opening angle of the cones is 15°. The chief rays reaching each detector define the axis of the cones. The axes of the two cones are parallel and are 13.7 mm apart. The axes of the cones are orthogonal to the surface of the triangular block 2

The spectral responses of the two detectors 24 and 25 are shown in FIG. 7. The spectrophotometer is designed to change-over between the two detectors at a wavelength of 1600 nm. The preferred first detector will give a signal when irradiated with light in the range 900 m to 1600 nm. At 900 nm, it will give a response of 0.2 A/W. At 1600 nm, it will give a response of 1.1 A/W. Between 1600 nm and 1700 nm, the sensitivity of the detector drops very quickly to zero. For practical purpose, the signal from the detector above 1600 nm will be too small to be usable. The detector will still give some signal below 900 nm. However, this is the lowest limit of the NIR spectrum and therefore there would not be chemically interesting information in this part of the spectrum. Therefore, the useful part of the spectrum that the detector will collect is 900 nm to 1600 nm.

The preferred second detector allows the extension of the collection spectrum to longer wavelength. The detector will give a response from 100 nm (0.8 A/W) to 2000 nm (1.1 A/W). Between 2000 m to 2100 nm, the response will drop rapidly to zero. Therefore, the detector will give an interpretable signal in the range 100 m to 2000 nm (and possibly up to 2100 nm).

The spectrophotometer also has the reference photodiode 36 placed in front of the QTH light source, although it could possibly be nearer the fibre optic connector. This photodiode is used to provide a reference measurement of the intensity of the light source. It also detects a fault in the light source.

Different geometries will be used for the optical probe, depending on the type of sample to be analysed and depending on the physical state of the sample (solid, liquid or gas). The present embodiment uses a probe that is suitable for diffuse reflectance measurements.

The design of the chassis has to account for the mechanical clearances and adjustments that are needed during both manufacture and use, and to deal with vibration and so forth.

In a preferred arrangement a machined block holds the two mirrors of the monochromator in place. The mirrors are brought in from the back and hit a lip at the front of the part that holds the mirror in position. A ring is then attached to the back of the mirror to hold it securely in place. A nylon washer may be used between the ring and the back of the mirror to act as a shock absorber if necessary and depending on the final environment in which the instrument will be used.

A machined holder is provided for the diffraction grating. The grating is placed in the holder in a similar way to the mirrors. The machined piece has a long shaft on the bottom that connects to the gearbox on the stepper motor allowing it to rotate. Apart from the rotation in one plane this part does not move and no adjustment is necessary. A further component in the form of a machined piece carries i) the filters, ii) the slits and iii) the detectors and there are two of each of these components. The component contains a turn screw system whereby the slits can be moved (through a distance of 1.5 mm) towards or away from the detectors. The detectors are equipped with thermoelectric Peltier effect coolers that require a heat sink. The photodetectors holder will also act as a cooling block.

The three machined pieces in place are all positioned relative to themselves on the machined chassis. Other components such as circuit boards, keyboard, battery holders are positioned outside this.

Vibration is often a big problem in instruments like these. In this instrument the entire internal chassis is suspended relative to the outer casing, so that it is free to move relative to the outer casing.

It is intended that the instrument is carried by a shoulder strap. The keypad is made of a membrane, ruggedised and water ingress resistant.

In the present embodiment, the spectrophotometer consists of a combination of electronic hardware and embedded software, which is required to control the measurement procedure and analyse the measured data, although in an alternative embodiment the analysis could be carried out elsewhere using data stored in and/or transmitted from the instrument.

FIG. 8 shows diagrammatically various components of the spectrophotometer, including a 12 volt input, a battery charger, a battery, a power supply, an on/off button, a light bulb, a reference photodiode, the grating and its stepper motor, the photodetectors, and, linked to a main board, a loudspeaker, Analogue to Digital Converter (ADC) clock, serial port connector, stepper motor controller, USB interface for connection to a computer PC, a 32 bit microcontroller, a PCMCIA interface, memory, a removable memory card, a numeric keypad, and a text display screen.

The power supply of the instrument preferably consists of two independent batteries packs. The first battery is solely used for the light source and is discussed below. The second battery powers the remaining system. A standard switch-mode voltage regulator can be chosen to efficiently supply power to the processor and its peripherals.

The analogue and the ADC (Analogue to Digital Converter) sections should be supplied separately to avoid interferences from the digital electronics. A linear regulator is advisable for this section combined with line filtering. The voltage supplied to this section should be as high as possible to maximise the input swing for the ADC. Assuming a drained battery voltage of 5V, and linear low-dropout voltage regulator would confidently achieve a supply voltage of 4.5V. It is advisable to locate the voltage regulator close to the analogue circuitry to avoid ‘pick-up’ on possibly long power supply lines.

Supplying a voltage of 12V externally charges both batteries. Each battery may have its own built-in battery charger.

The instrument includes a microprocessor to control and effect the following functions:

1. Record spectra
2. Spectrum analysis
3. User interface
4. Download data
5. Upload fingerprint spectra

Operations 1 and 2 define the spectrum acquisition time and typically may be completed in about 5 seconds. However, operations 3-5 require interaction with the interfaces. The required microprocessor controls the acquisition, calculates the spectra and communicates with the peripheral interfaces. There are a number of options available.

The physical separation of the system into a processor board and a set of daughter boards, i.e. analogue board, acquisition board and power supply board, offers the ability to upgrade individual system components without affecting others. Furthermore, each daughter board can be optimised in performance, i.e. noise, interference, etc. This approach also allows the purchase of a ready-made processor board that is bundled with an embedded OS such as Linux, thus saving development time. A later upgrade with a purpose built board is then still possible.

A important factor is the long-term stability of the instrument. If the instrument baseline drifts with time, there will be a bias introduced in the measurement with time. Therefore, while the measurement can still be precise, they will be inaccurate after some time. The instrument accuracy is determined by a calibration protocol. The calibration of the instrument is an important process, as it will determine the accuracy of the instrument and the long-term stability of the readings. The calibration process can be divided in two steps:

1. Instrument calibration. This calibration is used to relate the current intensity measurement done by the instrument to the intensity of light that is reflected/transmitted by the sample.
2. Experiment calibration. This calibration relates the intensity of light reflected/transmitted by the sample to the parameters of the physical or chemical process that are to be measured.

Instrument calibration is used to correct for different artefacts that are introduced by the instrument:

1. Fluctuation of the intensity of light bulb. As the light bulb and/or the batteries age, there will be a change in the intensity of the light.
2. Variation of the transmission of the optics. As the different optical components age in the instrument, there will be a variation in the transmission efficiency of the instrument.
3. Wavelength dependence. The different optical components do not transmit the light with the same efficiency for every wavelength. Therefore, the transmission efficiency of the system will show some wavelength dependence.
4. Variation of the sensitivity of the photodetectors. As the photodetectors age, they can show some variation in their efficiency (which could even be wavelength dependent).
5. Variation of the gain and offset of the amplifier. There can be a variation of gain and offset of the amplifier from day to day.

There are therefore two different types of artefacts to correct, namely wavelength dependence and variation of absolute intensity with time. These two artefacts are corrected by the calibration protocol. The calibration will be carried out at least once a day, before starting a new series of experiments. The instrument is calibrated by measuring the reflectance of a white tile. The white tile has a nearly flat reflectance spectrum). Therefore, the gain and offset of the instrument should be stable within 0.1% between two calibrations, i.e. for a period of 24 hours. This is the long term stability of the instrument.

Because of the wavelength dependence of the instrument sensitivity, the instrument will not record a flat spectrum for the white tile. The spectrum of the white tile will be used to correct all the other spectra recorded by the instrument during that day:

$${I}_{cor} ( λ ) = \frac{{I}_{meas} ( λ )}{{I}_{tile} ( λ )} \qquad Equation 1$$

Where I_{cor}(λ) is the corrected intensity of the sample at wavelength λ, Iₘₑₐₛ(λ) is the intensity measured by the instrument at wavelength λ and Iₜᵢₗₑ(λ) is the intensity measured for the tile at wavelength λ. If there is a variation of intensity of the light bulb between two calibrations with the white tile, this can also be accounted for by using the measure of the intensity of the light bulb from the reference photodiode:

$${I}_{norm} = {I}_{cor} \cdot \frac{{I}_{t 0}}{{I}_{t}} \qquad Equation 2$$

where Iₙₒᵣₘ is the sample intensity that has been normalised to account for the fluctuation of light intensity, I_{cor} is the intensity corrected according to Equation 1, Iₜ₀ is the intensity of the light bulb as measured by the reference photodiode at the time of the calibration with the white tile and Iₜ is the intensity of the light bulb as measured by the reference photodiode at the time of the measurement.

The instrument will read the intensity of the reference photodiode before and after recording the spectrum. If the intensity has fluctuated more than a given threshold, the spectrum will be rejected. The instrument will monitor the intensity of the light bulb during a few seconds. If a significant fluctuation is observed, the instrument will issue a warning message to the user to replace the light bulb or the batteries.

The reference photodiode should measure the light intensity with a precision of 0.1% (short-term precision).

The sampling frequency should be at least 1 kHz. However, if the ADC is sampling at a higher frequency, the data points can be averaged to reduce the noise.

The wavelength selection is done by rotating the grating by the stepper motor under the control of the stepper motor control board.

Each detector will record 500 data points during the rotation of the grating. The angle of the diffraction grating determines which wavelength of light is sent onto the photodetectors. It is therefore essential that the main micro-controller can keep track of the current position of the diffraction grating. Furthermore, to prevent mechanical damages, the diffraction grating must not be rotated beyond the limit angle in the clockwise and the anticlockwise direction. Therefore, three switches are used to give a feed back on the grating position to the main micro-controller:

Two limit switches detect when the diffraction grating is fully rotated clockwise and anticlockwise. These switches should be directly connected to the stepper motor control electronic so that the stepper motor is stopped automatically, without the main micro-controller intervention. The stepper motor control electronics would stop the stepper motor and send a “limit error” signal to the main micro-controller when a limit switch is closed.

An inductive slot spectrophotometer is provided, so that the microcontroller can keep track of the number of rotations that the stepper motor has actually done. The associated electronics should send a signal to the microcontroller each time a piece of metal goes through the slot spectrophotometer (i.e. at each complete revolution of the stepper motor shaft). The program in the microcontroller will keep track of the number of signals it has received.

Data memory is used for storing the recorded spectra and should, therefore, be non-volatile. Each measurement consists of:
3000 bytes for each spectrum (1000 data points @ 3 bytes/data point)
Two recorded spectra per measurement
Two fingerprint spectra (1000 data points @ 3 bytes/data point)
User data (100 bytes/spectrum)
Intermediate analysis results (assumed 3 kB)
Several background spectra (1000 data points @ 3 bytes/data point)
A minimum of 200 stored measurements.

Each measurement is composed in the worst case of 2*3 kB+2*3 kB (fingerprint)+3 kB (intermediate)+0.1 kB (user data)=15.1 kB. This assumes a new fingerprint spectrum for each measurement and a 1000 data point intermediate result. This would require a minimum of 3020 kB, or 2.95 MB. However, the size of the storage memory should be at least 4 MB as the previous calculation does not include the background spectra. This area of the data memory could be incorporated into the programming memory.

It is well known that the operating temperature of NIR spectrophotometers affects the spectra that are collected. The present embodiment is designed to operate in environments between −5° C. and +35° C. and the spectra are corrected within this temperature range. The temperature in the detection compartment will be monitored by a temperature monitor. As the shape of the NIR spectrum can change with the temperature, it is important to record the temperature in the detection compartment to detect whether the temperature has deviated too much from the calibration temperature. If a large deviation is detected, either a new calibration will be required or a compensation will have to be applied to the spectrum during the data analysis. The operation temperature range of the temperature spectrophotometer is −5° C. to +35° C. and it has an accuracy of ±1° C.

In a preferred embodiment the two detector responses will overlap and the suggested switchover point would be 1600 nm. The sensitivity of the detectors at 1600 nm may be for example approx 0.93 A/W for one detector and 1.03 A/W for the other; these are close enough to be balanced up by the software.

The response over the entire operating range varies considerably and this would be normalized to a common level in a calibration process. In addition to the variation in the sensitivity of the detectors, the light source output will also be changing over the operating wavelength range so a calibration scan against a known reflectance target would also take out those variations. Calibration would also be carried out with zero input light to establish the background noise level so that can be subtracted for the detected signal.

In the overlap range, data from both detectors can be used, the signal with the better signal/noise ratio taking preference and the two signals being used as a self calibration check near the crossover point.

The response of the detector in their working range of wavelengths is not flat. Therefore, even if one detector is illuminated with a light having the same intensity at all wavelength, the response of the detector as a function of wavelength will not be constant. It will have the shape of the curve shown in FIG. 7. One needs to correct for the spectral response of the detector. This will have to be done during a calibration step. The detector is illuminated with a light having a known spectral composition S_{ref}. The signal of the detector is measured as a function of the wavelength, and one therefore record the measured spectrum (Sₘₑₐₛ). The gain calibration factor G of the detector as a function of the wavelength is computed by dividing the reference spectrum by the measured spectrum: G=S_{ref}/Sₘₑₐₛ. In all subsequent measurements, the measured spectrum Sₘₑₐₛ is multiplied by a gain calibration factor G. This results in a corrected spectrum S_{corr} in which the effect of the sensitivity of the detector has been removed: S_{corr}=Smeas.G.

In practice the position may be more complex. It may be preferable for the gain factor G to take into account not only the spectral response of the detector, but also take into account the fact that the excitation light source spectrum is not flat. Therefore, a sample with a known reflectance spectrum (S_{ref}) will be used. The excitation light will be shined on the sample and the reflected spectrum will be measured (Sₘₑₐₛ). Now the gain factor will automatically take into account the spectrum of the excitation light and the spectral response of the two detectors

The spectrum of the light source will change as the light bulb gets older. Therefore, this calibration step will have to be done regularly. It may be that this calibration should be done at least once a day

The reference spectrum can be, for example, a sample of white tile, that will give a good reflection of light with a relatively flat reflectivity curve (as a function of wavelength).

At the same wavelength, the sensitivity of the two detectors will be different. However, multiplying the measured intensity by the gain factor (as described previously) will bring back the measurements from the two detectors to the same scale. Therefore, the two measurements will be directly comparable.

In the overlap region, as the same light intensity has been measured by the two detectors, preferably use is made of all the available information. Therefore, in the region of overlap the signal could be equal to the average of the corrected signal measured by the two detectors. However, because of the quantum noise of a detector the signal to noise ratio (S/N) of the detector is proportional to the square root of the number of detected photons. Therefore, a detector with a small sensitivity will detect fewer photons and will have a poorer signal to noise ratio. If one detector has a S/N ratio significantly lower than the other detector, it would be preferable to use only the information from the signal from the detector with the highest S/N. Otherwise one would add significant noise to an otherwise “clean” measurement. Therefore, preferably there is an overlap region in which the average of the two signals is used, which is defined using the S/R of the detectors. One needs to specify a threshold for the S/N ratio under which the signal from one detector is discarded. When the signal from one detector is above this threshold, it is taken into account. If both detectors have a signal above this threshold, the average of both signal is computed. The exact value of the threshold will be based on experimental evidence. However, it may be that a threshold S/N=5 would give acceptable results.

In one preferred embodiment, there is provided an electronic detection circuit with programmable amplifier. The light reaches the photodetector. The signal is converted into an electric current. The current is converted in voltage by an I-to-V converter. The voltage is then amplified by the programmable amplifier (which receive a feed back from the microcontroller on the required level of amplification). The analogue signal is converted to a digital signal by the Analogue to Digital Converter. The digital signal is sent to the microcontroller. In another embodiment there is an electronic detection circuit with two parallel amplifiers. In this case the voltage is sent in parallel to two amplifiers with different gains.

In preferred embodiments, the spectra of substances being analysed are compared with spectra stored in a library in the electronics module of the device so that the substance can be analysed. Thus, data processing means are provided for processing signals from the first and second photodetectors so as to produce data for use in identifying identify a compound or class of compounds in the sample. In some cases, the spectra obtained can be compared with library spectra stored elsewhere, such as on a laptop computer, a remote data processing facility and so forth. Different library spectra can be loaded into the instrument depending on the application required, for example using data cards or communications with other devices such as computers.

1. A spectrophotometer comprising means for directing light having a plurality of wavelengths to means arranged to produce a spectrum of different wavelengths distributed spatially, a first photodetector for receiving at any given time light in said spectrum within only a relatively narrow range of wavelengths, and means for effecting relative movement between the first photodetector and the spectrum so that the range of wavelengths received by the photodetector varies as a function of time; wherein there is provided a second photodetector which is displaced spatially from the first photodetector in the direction of increasing wavelength in the spectrum, the means for effecting relative movement between the first photodetector and the spectrum also effecting relative movement between the second photodetector and the spectrum, whereby at any given time the second photodetector receives light in said spectrum within a relatively narrow range of wavelengths which are substantially greater than those of the relatively narrow range of wavelengths being received simultaneously by the first photodetector at that time; and wherein the first photodetector has a first range of wavelengths over which it is operable and a first upper operating limit, and the second photodetector has a second range of wavelengths over which it is operable and a second upper operating limit, the second range overlapping the first range and the second upper operating limit being greater than the first upper operating limit.

2. A spectrophotometer as claimed in claim 1, wherein the means arranged to produce a spectrum of different wavelengths distributed spatially is a monochromator.

3. A spectrophotometer as claimed in claim 1, wherein the means for effecting relative movement between the first photodetector and the spectrum comprises means for moving an optical component of the monochromator.

4. A spectrophotometer as claimed in claim 3, wherein the optical component of the monochromator is a diffraction grating.

5. A spectrophotometer as claimed in claim 4, wherein the monochromator is a Czerny-Turner monochromator.

6. A spectrophotometer as claimed in claim 1, wherein the first and second photodetectors provide a combine operable wavelength range of at least about 1000 nm to about 2000 nm.

7. A spectrophotometer as claimed in claim 6, wherein the operable wavelength ranges of the first and second photodetectors overlap in a wavelength range of about 1400 nm to about 1600 nm.

8. A spectrophotometer as claimed in claim 7, wherein the first photo-detector has an operable wavelength range of about 900 nm to about 1600 nm, and the second photo-detector has an operable wavelength range of about 1400 nm to about 2000 nm.

9. A spectrophotometer as claimed in claim 1, wherein the spatial positions of the photodetectors and the operation of the means for effecting relative movement between the photodetectors and the spectrum are such that the first and second photodetectors are exposed to different but overlapping parts of the spectrum.

10. A spectrophotometer as claimed in claim 1, wherein there is provided a light source, a probe for directing light to a sample to be analysed and for receiving modified light from the sample, and means for directing the modified light to the means arranged to produce a spectrum of different wavelengths.

11. A spectrophotometer as claimed in claim 10, wherein data processing means are provided for processing signals from the first and second photodetectors so as to produce data for use in identifying identify a compound or class of compounds in the sample.

12. A spectrophotometer as claimed in claim 11, wherein in at least part of the region where the second range of wavelengths overlaps the first range of wavelengths, signals from both the first and second photodetectors are used.

13. A spectrophotometer as claimed in claim 10, comprising a portable body unit to be carried by a user, the body unit comprising a power source, the light source, a fibre optic connection to the probe to transmit light to the sample, a fibre optic connection to the probe to receive the modified light from the sample, the means arranged to produce a spectrum of different wavelengths, the photodetectors and the data processing means.

14. A spectrophotometer as claimed in claim 13, wherein the data processing means has access to a library of data associated with compounds or classes of compounds, for comparison with data derived from signals from the photodetectors.

15. A spectrophotometer as claimed in claim 13, wherein components of the means arranged to produce a spectrum of different wavelengths and the photodetectors are mounted within the body unit by shock absorbing means.

16. A spectrophotometer as claimed in claim 1, wherein the positions of the first photodetector and second photodetector are adjustable.

17. A spectrophotometer as claimed in claim 1, wherein between each of the photodetectors and the means arranged to produce a spectrum of different wavelengths there is provided a respective slit to limit the range of wavelengths of light reaching the photodetector at any given time.

18. A spectrophotometer as claimed in claim 17, wherein the position of each slit is adjustable.

19. A spectrophotometer as claimed in claim 1, wherein between each slit and the means arranged to produce a spectrum of different wavelengths is provided a respective filter to select a narrow band of wavelengths of light.

20. A spectrophotometer as claimed in claim 19, wherein the position of each filter is adjustable.

21. A spectrophotometer as claimed in claim 1, comprising a housing containing a light source, the means arranged to produce a spectrum of different wavelengths distributed spatially, and the first and second photodetectors; a first light transmitting connection between the housing and a probe for transmitting light from the light source to a sample to be analysed, a second light transmitting connection between the housing and the probe for receiving light from the sample to be analysed, and means for directing the received light to the means arranged to produce a spectrum of different wavelengths distributed spatially; wherein optical components of the means arranged to produce a spectrum of different wavelengths distributed spatially and the photodetectors are mounted rigidly to a chassis which is in turn mounted in the housing by means for at least partly absorbing shock and/or vibration.

22. A spectrophotometer as claimed in claim 1 wherein a light source is mounted by means of an adjuster providing for adjustment laterally with respect to the optical axis of the light source.

23. A spectrophotometer comprising a housing containing a light source, a first light transmitting connection between the housing and a probe for transmitting light from the light source to a sample to be analysed, a second light transmitting connection between the housing and the probe for receiving light from the sample to be analysed, and, within the housing, optical components comprising means for directing the received light to means arranged to produce a spectrum of different wavelengths distributed spatially, and at least one photodetector for detecting light in the spectrum, wherein the optical components are mounted rigidly to a chassis which is mounted within the housing by means for at least partially absorbing shock and/or vibrations.

24. A spectrophotometer comprising a housing containing a light source, a first light transmitting connection between the housing and a probe for transmitting light from the light source to a sample to be analysed, a second light transmitting connection between the housing and the probe for receiving light from the sample to be analysed, and, within the housing, means for directing the received light to means arranged to produce a spectrum of different wavelengths distributed spatially, and at least one photodetector for detecting light in the spectrum, wherein the light source is mounted by means of an adjuster providing for adjustment laterally with respect to the optical axis of the light source.

25. A spectrophotometer as claimed in claim 1, wherein the first and second photodetectors have different response characteristics so that they provide optimal outputs for different parts of the spectrum.

26. A spectrophotometer comprising excitation optics, detection optics and a microprocessor in which:
the excitation optics comprises a light source, light focussing means and means for guiding the light to a sample to be analysed;
the detection optics comprises means for receiving modified light from the analysed sample, and means to convert the received modified light from the sample into an electrical signal for interpretation by the microprocessor; and
the microprocessor comprises a reference library and a sample determination algorithm for comparing the electrical signal to a library of reference electrical signals to identify a compound or class of compounds in the sample,
whereby, in use, the light source emits light which is focussed by the light focussing means onto the means for guiding the light to the sample, the light guiding means guides the light to the sample, the sample modifies the received light and transfers a modified light signal indicative of the nature of the sample, which signal is received by the light receiving means which conveys the signal to the light converter means,
wherein the light converter means comprises a plurality of photodetectors which are capable of detecting different wavelengths of light such that the contiguous individual spectra are formed to make a spectrum of contiguous spectra which is usable for interpretation of the modified light to determine the nature of the sample, and wherein the spectrophotometer comprises an internal scaffolding upon which movement-sensitive components are mounted, said scaffolding being connected to an external cover by one or more shock-absorption means.
